(19) United States
(12) Patent Application Publication
(10) Pub. No.: US 2009/0150512 A1
(43) Pub. Date: Jun. 11, 2009

(54) METHOD FOR PRESENTING A CATALOG OF MULTIMEDIA CONTENTS TO A TERMINAL, CORRESPONDING SERVER, TERMINAL, REQUEST SIGNAL AND COMPUTER PROGRAM

(75) Inventors: Patrice Houze, Benodet (FR); Stephane Pallavicini, Chateaugiron (FR); Olivier Jean, Acigne (FR)

Correspondence Address: WESTMAN CHAMPLIN & KELLY, P.A., SUITE 1400, 900 SECOND AVENUE SOUTH, MINNEAPOLIS, MN, 55402, US

(73) Assignee: France Telecom, Paris (FR)

(21) Appl. No.: 11/917,704

(22) PCT Filed: May 12, 2006
(86) PCT No.: PCT/EP2006/062287

§ 371 Date: Jul. 28, 2008

(30) Foreign Application Priority Data
Jun. 16, 2005 (FR) 0506130

(51) Int. Cl. G06F 15/16; G06F 17/30

(52) U.S. Cl. 709/217; 709/233; 707/100; 707/E17.044

(57) ABSTRACT

A method is provided for presenting a catalog of multimedia contents transmitted by a server to a communications terminal, in response to a request sent by the terminal. The method includes adapting the catalog as a function of at least one first piece of information representing a current transmission channel and/or an available effective bit rate, so as to present to the terminal only multimedia contents capable of being transmitted to the terminal at a given point in time.

### CROSS-REFERENCE TO RELATED APPLICATIONS

This Application is a Section 371 National Stage Application of International Application No. PCT/EP2006/062287, filed May 12, 2006 and published as WO 2006/134008 on Dec. 21, 2006, not in English.

### BACKGROUND OF THE DISCLOSURE

1. Field of the Disclosure

The field of the disclosure is that of the presentation of multimedia contents to a communications terminal. More specifically, the disclosure relates to the presentation of a list, or catalog, of multimedia contents transmitted by a server to a communications terminal, enabling the user to select a multimedia content among several contents.

The great majority of communications terminals, for example radiotelephones or personal digital assistants (PDA), possess technical characteristics enabling the display of multimedia content. However, these characteristics can vary substantially from one terminal to another. The contents, for their part, vary greatly in terms of both format and size, and necessitate means of restitution that are very different from each other.

2. Prior Art Solutions

There already exist known techniques for presenting multimedia contents in radiocommunications terminals. These techniques imply numerous interactions with the user of the terminal. All these techniques require the user to have knowledge of the characteristics of the terminal and its capacities in order to make a choice, from a general multimedia catalog, of the multimedia contents likely to be displayed and taken into account.

These techniques are therefore to a great extent based on the user's choice and ability to understand the working of his or her terminal.

For example, to read an audiovisual content on his cellphone through the Internet, the user must have a priori knowledge of the following:
the streaming reader or readers installed at his terminal,
the downloading means installed at his terminal,
the type of his Internet connection,
the characteristics of his terminal (graphs, audio systems, decoding processing capacity, etc).

Thus, in the case of videos and depending on these parameters, the user must himself, from a list of videos proposed on a “Web” or “Wap” site, choose the one that he wishes to view on his telephone from a full list given by the service manager.

It may be planned, for each content, to specify the minimum characteristics necessary. Finally, either the selected video is properly displayed if all goes well, or else the user has made a mistake. In this case, the video is not restituted.

It is also possible that the communications network will not be capable of delivering the contents selected by the user. The video then is not downloaded.

3. Drawbacks of the Prior Art

One drawback of these prior art techniques is that they require the user to possess a minimum degree of knowledge of the computer and multimedia world. Indeed, the techniques cannot function without the user's action or the applications that he has embedded.

Another drawback of this prior art technique is that it does not ensure that the user can effectively view the selected multimedia content. Indeed, if the user has no information or, at the most, has little information on the types of multimedia contents presented in the catalog, the techniques do not ensure that the content selected by the user will be properly restituted at the user's terminal. The user therefore tries to download contents which he cannot, in any case, restitute at his terminal.

Yet another drawback of these techniques is that proposed catalogs are often deceptive, since a varyingly great part cannot be accessible to a user. The user believes that he has access to them, attempts a download and finally meets with failure. After a number of failed attempts, the user abandons the service which has not come up to his expectations.

This risk of failure is reinforced in radiocommunications by the fact that in certain places and/or in certain situations, the infrastructure does not enable the efficient transmission conditions for certain contents even if, in absolute terms, the terminal permits it.

### SUMMARY

These goals as well as others that shall appear here below are achieved by means of a method for presenting a catalog of multimedia contents transmitted by a server to a communications terminal, following a request made by said terminal.

According to the invention, such a method comprises a step for adapting said catalog to at least one first piece of information representing a current transmission channel and/or an available effective bit rate so as to present said terminal with only multimedia contents that can be transmitted by said terminal at a given point in time.

Thus, the invention relies on a novel and inventive approach to making multimedia contents available to the user of a communications terminal, using a first piece of information representing a current transmission channel and/or an available effective bit rate.

More specifically, the invention proposes a dynamic approach to the cataloguing of multimedia contents by using this first piece of information. Thus, only contents truly accessible at a given point in time, depending on the availability of the infrastructure, are proposed to the user.

In another place and/or at another time, the catalog could be different even if the terminal remains the same.

Thus, without special knowledge, the choice of the user is assisted, since it is only possible contents that are proposed to this user.

This first piece of information advantageously includes a standard type of indication of a communication available for said terminal at said given point in time, for example GSM, GPRS, EDGE, UMTS, xDSL, RNIS, RTC, etc. It can be used to refine the content of the catalog relative to the multimedia contents that can be restituted as a function of the state of the transmission channel.

Preferably, the adapting of the catalog also takes account of at least one second piece of information representing characteristics of said terminal, so as to present said terminal with only multimedia contents that can be restituted by said terminal.

The second piece of information can especially comprise at least one of the pieces of information belonging to the group comprising:
a screen format;
an image restitution capacity;
a sound restitution capacity;
a processing capacity;
a storage capacity;
a list of available applications.

This second piece of information is used to refine the presentation of said catalog of multimedia contents in the form of contents that can be restituted by said terminal as a function of the technical characteristics proper to the terminal.

Advantageously, said server manages a first database associating said second piece of information or pieces of information with each type of terminal.

This first database gives greater depth to the requests sent out by a terminal before it is taken into account for constituting the catalog.

Preferably, the adapting of the catalog also takes account of at least one third piece of information representing a subscription and/or a preference of the user of said terminal in order to adapt the content of the catalog even more precisely to the terminal and take account of the characteristics of the user, in selecting only the contents pertaining to his subscription and/or to his usual preferences.

It is also possible to propose or not propose contents to certain users that are payable and/or reserved to certain users, for example according to access rights that said users would have paid for and/or parental control characteristics. It is also possible to propose contents to a user that are adapted to his tastes.

Advantageously, this third piece of information is stored in a second database of users, addressable by means of an identifier of said user, from the server interacting with the user terminal.

The second database can also associate, with each user, a list of at least one application installed on said terminal. This list may also enable the defining of an alternative fallback strategy in the very unlikely case where neither the first nor the second piece of information is available at the time of the request. This fallback strategy may, for example, consist in assigning a minimum default profile rather than displaying a deceptive error message.

According to an advantageous embodiment of the invention, the request sent out by said terminal to the server is a request in the http format, comprising a header. This header is used to insert said first, second and/or third pieces of information in order to provide said server with all the parameters enabling it to process the user's demand.

Thus, a simple and efficient packaging is done of the different pieces of information in the request.

The invention also relates to the structure of such a request, comprising at least one field carrying said first piece of information.

The invention also relates to the terminals capable of implementing the method described here above and sending such a request (request signal) and the corresponding servers.

The invention finally pertains to computer programs comprising instructions to implement all or part of this method, in the terminals, servers and secondary elements of the transmission channel.

### BRIEF DESCRIPTION OF THE DRAWINGS

Other features and advantages shall appear more clearly from the following description of a preferred embodiment, given by way of a simple illustrative and non-restrictive example and from the two appended drawings, of which:

FIG. 1 is a block diagram showing the processing of a request sent out by the communications terminal for accessing the multimedia contents of a catalog;

FIG. 2 illustrates the format of this request sent out by the terminal of FIG. 1, when it is distributed to the server responsible for processing;

FIG. 3 describes an embodiment of a presentation of a catalog of optimized multimedia contents following a request sent out by the terminal;

FIG. 4 provides a schematic illustration of the structure of the terminal of FIG. 1; and

FIG. 5 provides a schematic illustration of the structure of the server of FIG. 1.

### DETAILED DESCRIPTION OF ILLUSTRATIVE EMBODIMENTS

### 1. Principle

In the context of the present disclosure, the description focuses on the automatic presentation of the multimedia contents that can be restituted to a radio communications terminal according to parameters and, especially, the current state of a channel for transmission to said terminal and/or the technical characteristics of said terminal.

The general principle of an embodiment of the invention is based therefore on taking account of a piece of information representing the transmission channel in order to optimize the catalogs present in a radiocommunications terminal. An embodiment of the invention also takes account of the information on the type of terminal of the user.

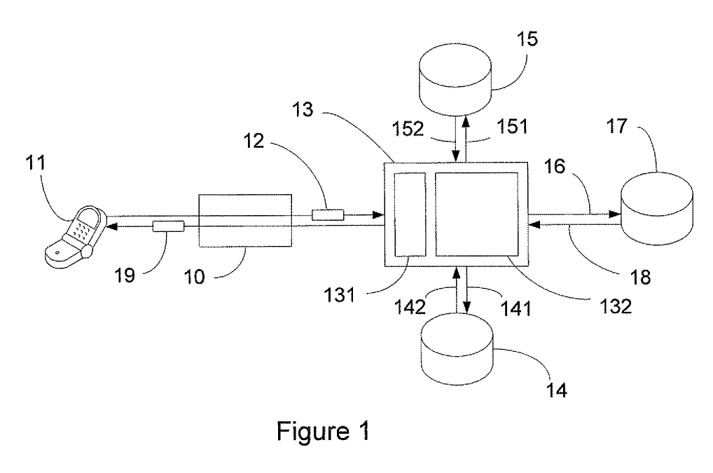

FIG. 1 is a simplified illustration of an example of architecture implementing an embodiment of the invention. The radiocommunications terminal 11 sends out a request 12 addressed to a multimedia content server 13 (consisting for example of a management server of the http protocol 131 and an application server 132) through a transmission channel.

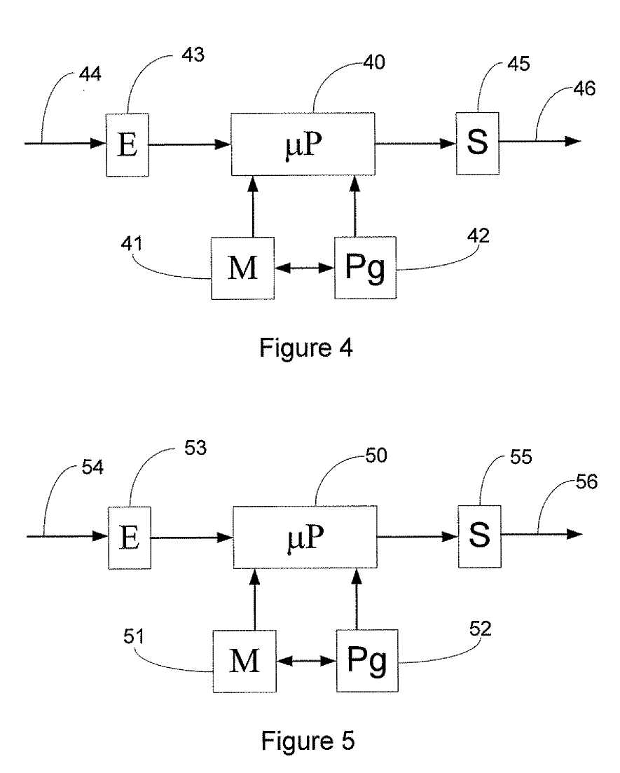

The structure of the terminal 11 is illustrated schematically by FIG. 4. It comprises a memory M 41 equipped with a microprocessor μP driven by a computer program (or application) Pg 42. At input, the processing unit 40 receives server responses 44 through a network input interface module E 43, which the microprocessor μP processes, according to the instructions of the program Pg 42, to generate requests 46 which are transmitted via a network output interface module S 45.

The request 12 sent out by the terminal 11 contains especially a piece of information identifying the type of terminal. This piece of information is inserted by the terminal 11 when the request 12 is sent out.

An apparatus dedicated to this transmission channel 10 adds a piece of information, representing its state, to the request 12 for example by encapsulation in the header of the request. This piece of information can also be encapsulated in the request 12 directly by the terminal 11, prior to its transmission.

A piece of information of this kind can be an indication of the bit rate available on the transmission channel, depending on its congestion and/or it may be an indication of the type of radiocommunications standard accessible at the terminal (GSM, GPRS, UMTS, EDGE, xDSL, RNIS, RTC, etc.) as a function of the network coverage of the geographical zone in which it is located, and/or again an indication of a level of quality of the transmission channel, which is a function for example of the distortions related to the configuration of the terrain.

The structure of the server 13 is illustrated schematically by FIG. 5. It comprises a memory M 15 and a processing unit 50 equipped with a microprocessor μP which is driven by a computer program (or application) Pg 52. At input, and through a network input interface module E 53, the processing unit 50 receives customer requests 54 which the microprocessor μP processes, according to the instructions of the program Pg 52, to generate responses 56 which are transmitted through a network output interface module S 55.

The server 13 therefore uses the information available to it in the header of the request 12 in order to contact a data base of the terminals 14 and/or a database of the subscribers 15 in order to obtain precise information on the user's terminal (request 141 and response 142) on the one hand, and on the subscription and/or the user's preferences on the other hand (request 151 and response 152).

The database of the terminals 14, which can be managed directly by the content server 13 or by an apparatus with which it communicates, groups together for example, for each terminal of a fleet managed by the content server 13, a set of technical characteristics of the terminal, such as the power of its processor, the size of its screen etc.

Similarly, the subscribers' database 15, which can also be managed directly by the content server 13 or by an apparatus with which it communicates, groups together, for example, for each user of the radiocommunications services managed by the server 13, characteristics of the user's subscription such as the maximum size of data that can be exchanged during a given subscription period, the type of subscription or again the type of software installed in the terminal.

Access to either of these two databases, using the data available in the initial request from the terminal 12, enables the server 13 to define a new request 16 which is sent out on the database of the catalogs 17. This new request is an optimized request that is also built from information added in the request 12 by the transmission channel 14 or again by the terminal 11.

The database of the catalogs 17 then sends the response 18 to the server 13. This response 18 contains a list of multimedia contents accessible to the terminal 11 as a function of the technical characteristics of this terminal 11, the state of the channel 14 and, possibly, the subscription taken out by the user. This user then builds the page that will be presented to the terminal and sends it to this terminal by making use of the response 19 made to the initial request 12.

A particular example of implementation of the process of FIG. 1 can be obtained from the following technical base which comprises:
A multimedia content server 13 comprising:
   A server for the management of the http protocol (Web server) 131 which, for example, may be of the IIS, Apache, Netscape, SUN iPlanet (registered marks) types. It is this server that receives the request 12 and builds the response (the adapted catalog) 19. This response is constituted, for example, by the pages of the video portal built dynamically, presenting access to html (hypertext markup language) and wml (wireless markup language) video contents as well as the better streaming or downloading links (URLs or uniform resource locators). They too are built dynamically. The request 19 is intended for the user of the radiocommunications terminal 11. The server 131 gives the applications server 13 the set of parameters needed for the dynamics of the system extracted from the http header.
An applications server 132. It may advantageously be based upon:
the Java language and may be implemented in the form of independent modules (“servlets”) or in the form of a dynamic generator of JSP (Java server page) content, for example IBM WebSphere, BEA Web Logic, Netscape Enterprise server, Oracle Application Server, SUN Iplanet (registered marks),
   an ASP/COM (ASP.NET, Microsoft Transaction Server (registered marks) type language,
   an implementation of Services Web or a PHP type language.
      An applications server of this kind implements the following functions:
retrieval from the “user-agent” field of the http requests to know the type of terminal connected. The result can be used for example to determine the embedded reader or readers and/or the installed navigators.
extraction of a terminal identifier (“U-A profile”) to interrogate the “terminals” database 14. The result can be used to know the characteristics of the terminal (basic and, if necessary, optional characteristics), for example its screen characteristics, the number of colors and/or the number of pixels.
retrieval from the “accept” field of the http requests 12 to have knowledge, if necessary, through “content types” supported by the mobile telephone, of the application or applications embedded in the terminal and especially the reader or readers installed in the terminal.
interrogation of the “contents” database 17 to retrieve the stream of contents best adapted to the user's terminal.
building the page having links to the best suited contents depending on the multimedia capacity of the terminal or an error page if the terminal is not suited to streaming or downloading.

In one alternative embodiment of the invention, it is also possible to do without the applications server by using a dynamic generation technology directly supported by the web servers 131 such as CGI or ASP. These technologies indeed provide means of processing information substantially comparable to that proposed by the application server.

The technical means implemented also include three databases:
the “terminals” database 14 which contains the multimedia characteristics of the terminals concerned, for example the power of its processor, the size of its screen or again its decoding capacities or the size of its memory, for downloading especially.
the database of the user's subscription/preferences 15, containing the characteristics of the user's subscription, for example its duration, the number of downloading operations authorized as well as its preferences, especially as regards the software installed on its terminal, for example the content processing and restitution software and/or information on his tastes and specific characteristics (region, profession, age, sex etc).
the “catalog” database 17 containing references and descriptions of all the contents available for the video portal and for the terminals concerned.

The databases may, for example, be based on tools such as MS SQLServer, MS Access, Oracle 8i, IBM DB2, Oracle, MySQL (registered marks).

The requests sent to the databases (141, 151, 16) a as well as the responses to these requests (142, 152, 18) should enable both retrieval of the characteristics of the terminal and the construction of the video page presenting the links best adapted to the user's terminal.

### 2. Example of a Request

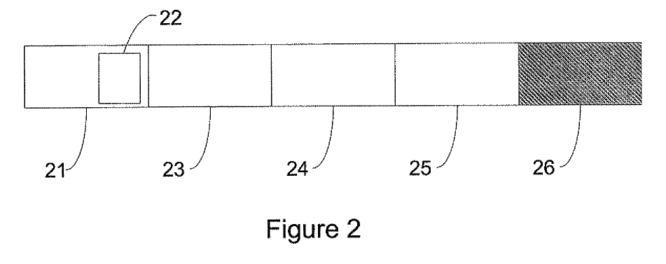

According to an embodiment of the invention, the request 12 is sent out by the radiocommunications terminal. It can be supplemented by the terminal itself or gradually by one or more intermediate apparatuses of the network. An example of a supplemented request structure is illustrated in FIG. 2. This figure comprises:
a first “user agent” field 21: this is a field given by all the navigators embedded in the radiocommunications terminals that have multimedia capacities. This field identifies the type of terminal,
a specific “user agent profile” piece of information 22 contained in the first field 21: this is a link (URL) given by the terminal builder and is used to retrieve all the technical characteristics of the terminal and is used to verify the characteristics of the terminal directly on the its builder's Internet site.
a third field 23 called an “accept” field used to retrieve the MIME (multi-purpose Internet mail extensions) types supported by the terminal and therefore the embedded multimedia reader or readers.
a fourth field 24 known as the “bearer” field (or “first information” according to the claims) providing information on the type of transmission channel used by the radiocommunications terminal, for example GPRS or UMTS, xDSL, ISDN, RTC and/or any information pertaining to a measured instantaneous bit rate.
a fifth field 25, used to exploit the characteristics proper to the user of the radio communications terminal, for example the terminal subscription offer;
a last field 26, namely the list or catalog requested by the terminal.

This structure of a request signal is very simple and relies on known bases (http). It requires no complex means whether on the terminal side or on the server side or on the side of the intermediate elements of the transmission channel.

### 3. Example of Implementation

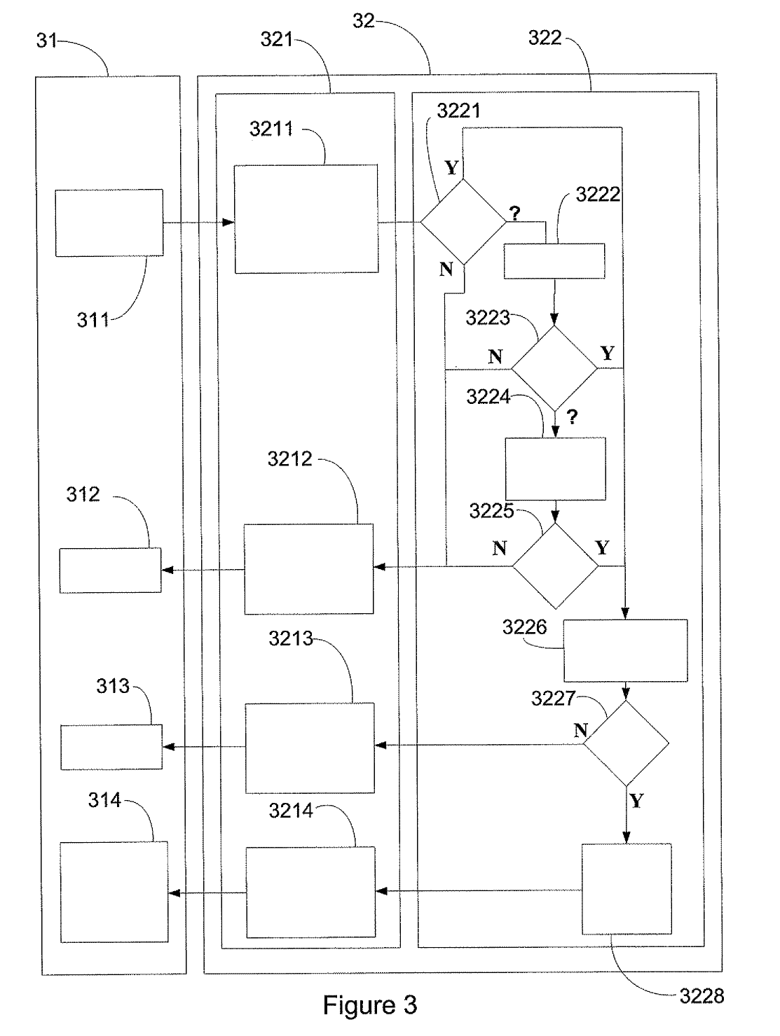

Referring to FIG. 3, we present an embodiment of the method for presenting a dynamic audiovisual file following a request sent out by the terminal.

The principle of the embodiment of the system is the following:
The user, working through the navigator 31 embedded in his radiocommunications terminal, launches an HTTP request 311 which invokes a generic audiovisual file on the video portal, designed to broadcast contents in streaming or downloading mode.
the system 32, using the HTTP protocol management server 321, retrieves the fields of the request concerning the user's terminal: User Agent (UA) 21,(URL) link of the “User Agent Profile” (UAProf) 22, “accept” 23, and transmits them 3211 to the application server 322. It also retrieves the generic video link chosen by the user 3211.
The application server:
   makes an attempt in an initial stage to verify whether the terminal is compatible with streaming by means of the “accept” field of the http header 3211.
   if the response to this verification 3211 is negative, the application server 322 asks the HTTP protocol management server 321 to build a response indicating that it is not possible to read the file selected by the user (3212). The HTTP protocol management server 321 transmits this response to the radiocommunications terminal 31 which displays it (312).
   if the response to the previous verification 3221 does not make it possible to determine the capacities of the terminal, the applications server 322 tries to check whether the terminal is compatible with the streaming by means of the “user agent” field 21 in interrogating (3222) the “terminals” database.
   if the response to the request for interrogating the database of the terminals 3222 is negative, the application server 322 asks the HTTP protocol management server 321 to build a response indicating that it is not possible to read the file selected by the user (3212). The HTTP protocol management server 321 sends this response to the radiocommunications terminal 31 which displays it (312).
   if the response 3223 to the request for interrogating the database of the terminals 3222 does not make it possible to determine the capacities of the terminal, the application server tries to verify that the terminal is compatible with the streaming by means of the identifier of the user in interrogating the “user preferences” database 3224. In this database, the user will have entered information, during the previous session, on the streaming technology that he wishes to use.
   if the response 3225 to the request on this database 3224 is negative, the application server 322 asks the HTTP protocol management server 321 to build a response indicating that it is not possible to read the file selected by the user 3212. The HTTP protocol management server 321 transmits this response to the radiocommunications terminal 31 which displays it 312.

If, through one of the above steps, the application server succeeds in identifying the capacities of the terminal, said application server then interrogates the content database 3226 in order to check that the multimedia file chosen by the user is truly available in the appropriate format:
if the response 3225 to the request on this database 3224 is negative, the application server 322 asks the HTTP protocol management server 321 to build a response indicating that the requested filed is not available to the radiocommunications terminal of the user 3213. The HTTP protocol management server 321 transmits this response to the radiocommunications terminal 31 which displays it (313).
if the response 3227 to the request on this database of the contents 3226 is positive, the application server 322 builds the optimum link (URL) 3228 and asks the management server of the HTTP protocol 321 to build a response 3214 by which the radio communications terminal of the user 31 can access the content 314.

Naturally, many variants and adaptations can be made in the implementation of this method, provided that at least one piece of information representing the channel is taken into account to adapt the catalog.

### 4. Other Embodiments

According to another preferred embodiment, it can be planned to implement an invocation of a list or catalog of multimedia data by means of the terminal. In this embodiment, the terminal, using the http request, invokes a list or page of said catalog. The server then builds this page or this list using information representing the channel and/or the terminal so as to present the terminal only with the multimedia content that can be restituted by the terminal.

Furthermore, the invention is not limited to radiotelephony type terminals but can be applied more generally to many types of terminals such as PDAs, microcomputers etc.

An aspect of the disclosure provides a technique for presenting multimedia catalogs to simplify the choice of the users and not oblige them to have technical knowledge of the characteristics of their terminal.

A technique of this kind eliminates or minimizes the risks of attempts to download contents that cannot be played on the terminal as a function of these characteristics and the state of a transmission channel at a given point in time.

It must be noted here that this last-named point is an integral part of an exemplary embodiment of the invention. This problem identified by the inventors has never before been identified or dealt with.

Yet another aspect of the disclosure proposes a technique of this kind that does not call for any particular action or knowledge on the part of the user.

In other words, a technique of this kind ensures the proper restitution of the contents of a multimedia catalog presented to a user at his terminal.

Although the present disclosure has been described with reference to one or more examples, workers skilled in the art will recognize that changes may be made in form and detail without departing from the scope of the disclosure and/or the appended claims.

1. Method for presenting a catalog of multimedia contents, the method comprising:
transmitting the catalog of multimedia contents by a server to a communications terminal, following a request made by said terminal; and
adapting said catalog to at least one first piece of information representing at least one of a current transmission channel or an available effective bit rate, so as to present said terminal with only multimedia contents that can be transmitted by said terminal at a given point in time.

2. Method according to the claim 1, wherein said first piece of information comprises a standard type of indication of communication available for said terminal at said given point in time.

3. Method according to claim 1, wherein said adapting of the catalog takes account also of at least one second piece of information representing characteristics of said terminal, so as to present said terminal only with multimedia contents that can be restituted by said terminal.

4. Method according to the claim 3, wherein said second piece of information comprises at least one of the pieces of information belonging to the group comprising:
a screen format;
an image restitution capacity;
a sound restitution capacity;
a processing capacity;
a storage capacity;
a list of available applications.

5. Method according to the claim 4, wherein said server manages a first data base associating said second piece of information or pieces of information with each type of terminal.

6. Method according to claim 1, wherein said adapting of the catalog also takes account of at least one further piece of information representing at least one of a subscription or a preference of a user of said terminal.

7. Method according to the claim 6, wherein said further piece of information is stored in a database of users, addressable by an identifier of said user.

8. Method according to the claim 7, wherein said database of users also associates a list, with each user, of at least one application installed in said terminal.

9. Method according to claim 1, wherein said request comprises a request in an http format, comprising a header and, said first piece of information is inserted in said header.

10. Multimedia contents server comprising:
an interface module, which transmits a catalog of multimedia contents to a communications terminal in response to a request sent by said terminal,
a processor, which adapts said catalog as a function of at least one first piece of information representing a current transmission channel and/or an available effective bit rate, so as to present said terminal with only multimedia contents that can be transmitted by said terminal at a given point in time.

11. Computer program product stored on a computer-readable carrier wherein the computer program product comprises program code instructions implementing a method for presenting a catalog of multimedia contents, the method comprising:
transmitting the catalog of multimedia contents by a server to a communications terminal, following a request made by said terminal; and
adapting said catalog to at least one first piece of information representing at least one of a current transmission channel or an available effective bit rate, so as to present said terminal with only multimedia contents that can be transmitted by said terminal at a given point in time.

12. Method comprising:
requesting a catalog of multimedia contents by a communications terminal through a request sent by said terminal, and
inserting, by said terminal, at least one piece of information representing the terminal's capacities in this request.

13. Computer program product stored on a computer-readable carrier wherein the product comprises program code instructions implementing a method for invoking a multimedia content catalog, the method comprising:
requesting the multimedia content catalog by a communications terminal through a request sent by said terminal, and
inserting, by said terminal, at least one piece of information representing the terminal's capacities in the request.

14. Communications terminal comprising:
interface module, which sends a request to a server;
a display, which displays a catalog of multimedia contents transmitted by said server in response to said request; and a processor, which inserts into said request, at least one first piece of information representing at least one of a current transmission channel or an available effective bit rate, so that said catalog contains only multimedia contents that can be transmitted to said terminal at a given point in time.

15. Signal for requesting presentation of a catalog of multimedia contents transmitted by a server to a communications terminal, following a preliminary request sent by said terminal,
wherein the signal comprises a field containing at least one first piece of information representing a current transmission channel and/or an available effective bit rate, so as to enable an adaptation of said catalog by said server and so as to present said terminal with only multimedia contents that can be transmitted to said terminal at a given point in time.
